(19) United States
(12) Patent Application Publication
(10) Pub. No.: US 2013/0001391 A1
(43) Pub. Date: Jan. 3, 2013

(54) FASTENER AND MOUTING APPARATUS WITH FASTENER

(75) Inventors: PO-WEN CHIU, Tu-Cheng (TW); WEN-HU LU, Shenzhen City (CN); ZHAN-YANG LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/443,006

(22) Filed: Apr. 10, 2012

(30) Foreign Application Priority Data
Jun. 30, 2011 (CN) 201110181609.X

(51) Int. Cl. F16M 13/00; F16B 37/00

(52) U.S. Cl. 248/309.1; 411/111

(57) ABSTRACT

A mounting apparatus includes a first component, a second component, a mounting member, and a fastener. The first component includes a back portion and a front portion opposite to the back portion and defines a concave slot. The second component includes a positioning hole. The fastener includes a main body with a screw hole, a resilient portion extending from an end of the main body, and a supporting portion extending from an outer surface of the main body. The supporting portion is adjacent to the resilient portion. The resilient portion is in a deformed state between the back portion and the front portion, the supporting portion is adhered to the back portion, and the mounting member is engaged in the positioning hole and the screw hole to secure the second component to the first component.

### BACKGROUND

1. Technical Field

The present disclosure relates to mounting apparatuses, and particularly to a mounting apparatus with a fastener for securing a first component to a second component.

2. Description of Related Art

Mounting apparatuses are usually used to secure two or more components together. A typical mounting apparatus is composed of a male member, such as a screw, and a female member, such as a screw hole. Generally, the male screw includes a head and a threaded body. The female member defines a threaded hole. A first component defines a first through hole, and a second component defines a second through hole. In use, the male screw shaft inserts through the first through hole and the second through hole. The male screw head abuts against the first component, and the end portion of the male screw shaft is secured to the first through hole and the second through hole by soldering. However, the appearance of the first component will be affected by jointing. Therefore there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of a fastener in accordance with an embodiment.

FIG. 2 is similar to FIG. 1, showing in a different aspect.

FIG. 3 is an exploded, isometric view of a mounting apparatus in accordance with an embodiment.

FIG. 4 is an assembled view of FIG. 3.

FIG. 5 is a partial, cross-sectional view of FIG. 4 along line V-V.

FIG. 6 is similar to FIG. 3, showing in a different aspect.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

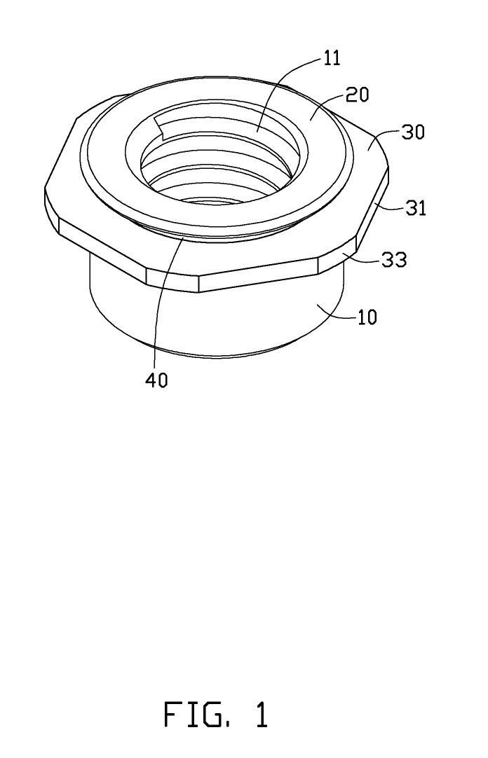

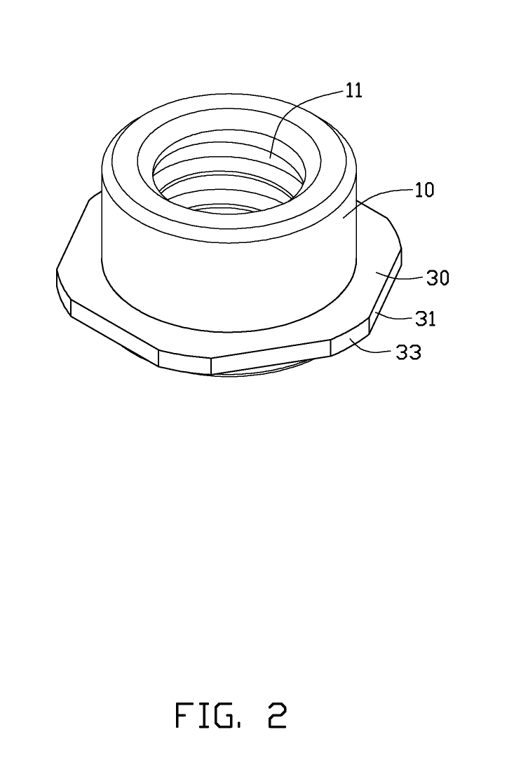

Referring to FIGS. 1-2, a fastener, in accordance with an embodiment, includes a main body 10, a resilient portion 20 extending outward from an end of the main body 10, and a supporting portion 30 extending from an outer surface of the main body 10. The supporting portion 30 is adjacent to the resilient portion 20, and a gap 40 is defined between the supporting portion 30 and the resilient portion 20.

A screw hole 11 is defined in the center of the main body 10 and extends through the resilient portion 20. In one embodiment, the main body 10 can be a cylinder or a cuboid.

The resilient portion 20 is elastic, and an outer edge of the resilient portion 20 is curved. In one embodiment, the resilient portion 20 is a ring-shaped, and an external diameter of the resilient portion 20 is greater than that of the main body 10.

The supporting portion 30 includes a curved edge assembly. The curved edge assembly includes a plurality of first curved edges 31 and a plurality of second curved edges 33. Each of the plurality of second curved edges 33 is located between two of the plurality of first curved edges 31. In one embodiment, the plurality of first curved edges 31 includes six first curved edges 31, and the plurality of second curved edges 33 also includes six second curved edges 33. A length of each of the plurality of first curved edges 31 is greater than that of each of the plurality of second curved edges 33. A distance between the main body 10 and a center portion of the plurality of first curved edges 31 is less than that of the main boy 10 and a center portion of the plurality of second curved edges 33.

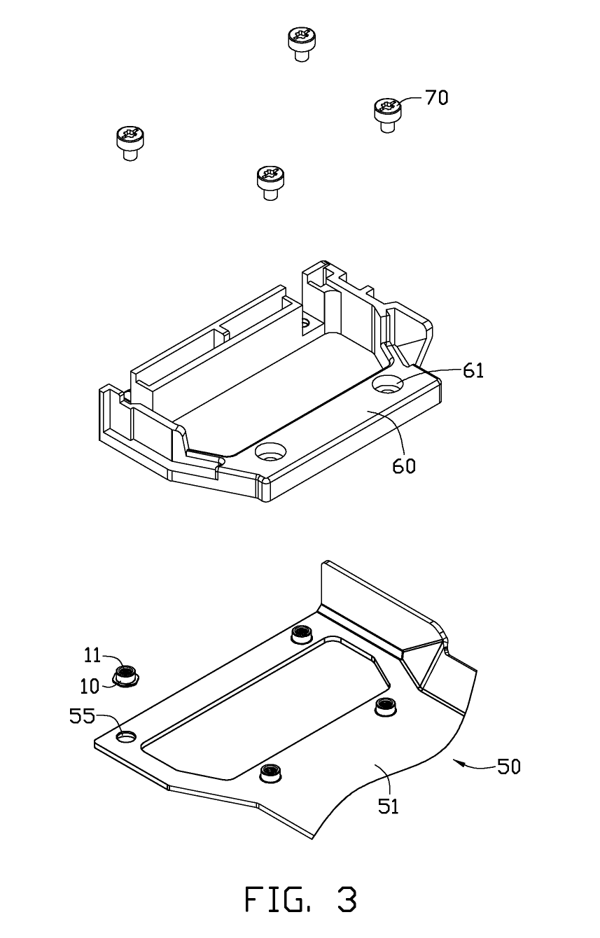

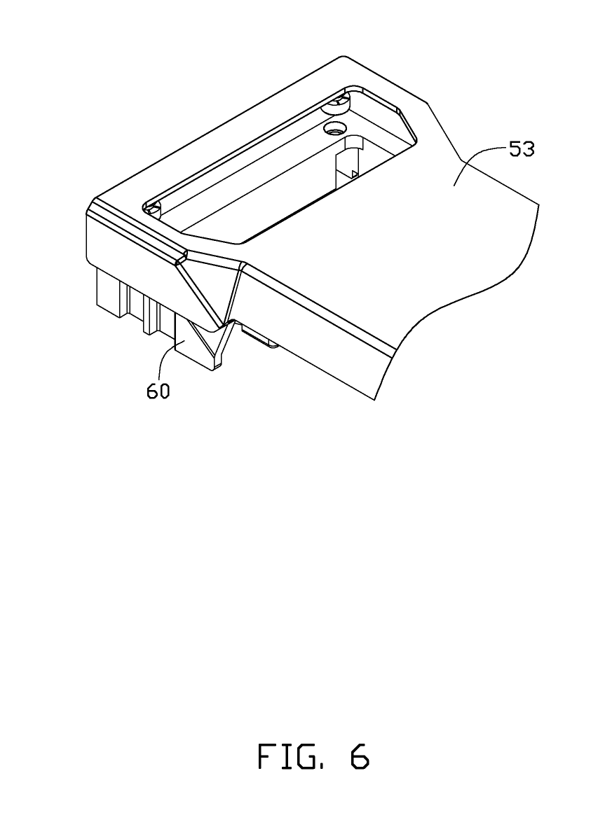

Referring to FIG. 3, the mounting apparatus with the fastener is provided for securing a first component 50 to a second component 60. The first component 50 may be a plate used for a computer case, such as a decorate plate, and the second component 60 may be a positioning member, such as a handle. The first component 50 includes a back portion 51 and a front portion 53 (shown in FIG. 6) opposite to the back portion 51. Four concave slots 55 are defined in the first component 50. Each of the four concave slots 55 extends from the back portion 51 to the front portion 53 but not through the front portion 53. The second component 60 defines four positioning holes 61 corresponding to the four concave slots 55. In one embodiment, a diameter of each of the four concave slots 55 is less than an external diameter of the resilient portion 20, and the depth of each of the four concave slots 55 is substantially equal to a distance between the resilient portion 20 and the supporting portion 30.

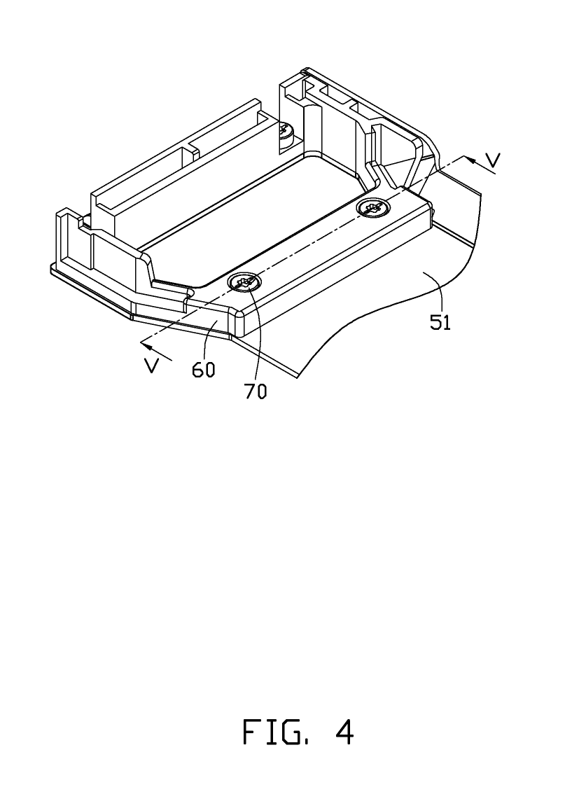

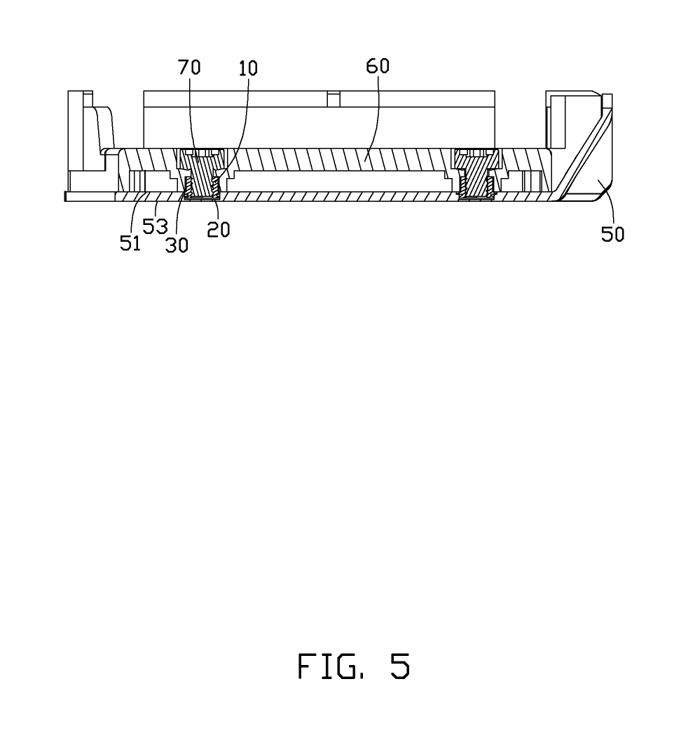

Referring to FIGS. 4-6, in assembly, the resilient portion 20 is deformed to engaged into the concave slot 55. Because the depth of each of the four concave slots 55 is substantially equal to a distance between the resilient portion 20 and the supporting portion 30, the supporting portion 30 can be adhered to the back portion 51. The supporting portion 30 is engaged with the back portion 51 by jointing, so that the fastener is secured to the back portion 51. The supporting portion 30 can be easily engaged with the back portion 51 because the first curve edges 31 and the second curve edges 33 have different lengths. The external diameter of the resilient portion 20 is greater than the diameter of the concave slot 55, and the resilient portion 20 can be tightly engaged in the concave slot 55.

The second component 60 is attached to the back portion 51, and the main body 10 extends through the positioning hole 61. A mounting member 70 is engaged into the positioning hole 61 and the screw 11, to secure the second component 60 to the first component 50.

In disassembly, the mounting member 70 is removed from the positioning hole 61 and the screw 11, to disengage the second component 60 from the first component 50. The resilient portion 20 is deformed to removed from the concave slot 55, so that the fastener can be detached from the first component 50.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A fastener comprising:
a main body defining a screw hole adapted to receive a mounting member;
a resilient portion extending from an end of the main body; and
a supporting portion extending from an outer surface of the main body, and the supporting portion adjacent to the resilient portion;
wherein the resilient portion is in a deformed state between a back portion of a first component and a front portion of the first component, and the supporting portion is adapted to be adhered to the back portion of the first component.

2. The fastener of claim 1, wherein the resilient portion is a ring-shaped.

3. The fastener of claim 1, wherein the supporting portion comprises a plurality of first curved edges and a plurality of second curved edges, each of the plurality of second curved edges is located between two of the plurality of first curved edges, and a length of each of the plurality of first curved edges is greater than that of the plurality of second curved edges.

4. The fastener of claim 3, wherein the plurality of first curved edges comprises six first curved edges, and the plurality of second curved edges comprises six second curved edges.

5. The fastener of claim 3, wherein a distance between the main body and a center portion of the plurality of first curved edges is less than that of the main body and a center portion of the plurality of second curved edges.

6. The fastener of claim 1, wherein an external diameter of the resilient portion is greater than that of the main body.

7. A mounting apparatus comprising:
a first component comprising a back portion and a front portion opposite to the back portion; the first component defining a concave slot;
a second component comprising a positioning hole;
a mounting member; and
a fastener comprising:
a main body defining a screw hole;
a resilient portion extending from an end of the main body; and
a supporting portion extending from an outer surface of the main body, and the supporting portion adjacent to the resilient portion;
wherein the resilient portion is in a deformed state between the back portion and the front portion, the supporting portion is adhered to the back portion, and the mounting member is engaged in the positioning hole and the screw hole to secure the second component to the first component.

8. The mounting apparatus of claim 7, wherein the resilient portion is a ring-shaped.

9. The mounting apparatus of claim 7, wherein the supporting portion comprises a plurality of first curved edges and a plurality of second curved edges, each of the plurality of second curved edges is located between two of the plurality of first curved edges, and a length of each of the plurality of first curved edges is greater than that of the plurality of second curved edges.

10. The mounting apparatus of claim 9, wherein the plurality of first curved edges comprises six first curved edges, and the plurality of second curved edges comprises six second curved edges.

11. The mounting apparatus of claim 9, wherein a distance between the main body and a center portion of the plurality of first curved edges is less than that of the main boy and a center portion of the plurality of second curved edges.

12. The mounting apparatus of claim 7, wherein an external diameter of the resilient portion is greater than that of the main body.
